(19) United States
(12) Patent Application Publication
(10) Pub. No.: US 2020/0327607 A1
(43) Pub. Date: Oct. 15, 2020

(54) AUCTION IMPROVEMENTS

(71) Applicant: GAVL AUST PTY LTD, Cremome (AU)

(72) Inventors: Leith DONALDSON, Hawthorn East (AU); Michael ARTUP, Hawthorn East (AU); Joel SMITH, Hawthorn East (AU)

(73) Assignee: GAVL AUST PTY LTD, Cremorne (AU)

(21) Appl. No.: 16/094,603

(22) PCT Filed: Apr. 20, 2017
(86) PCT No.: PCT/AU2017/050360

§ 371 Date: Oct. 18, 2018

(30) Foreign Application Priority Data
Apr. 22, 2016 (AU) 2016901502

(51) Int. Cl. G06Q 30/08; G06Q 30/06; G06Q 50/16; G06F 3/0482

(52) U.S. Cl. CPC G06Q 30/08; G06F 3/0482; G06Q 50/163; G06Q 30/0643

(57) ABSTRACT

A computer implemented system for facilitating an auction comprising: a processor; a data store; and a communications interface; wherein the processor is configured to: receive auction information and optionally cause storage of at least part of said information in the data store; and cause transmission of auction information via the communications interface to one or more computing devices associated with a network.

### CROSS REFERENCE TO RELATED APPLICATIONS

This patent application is a National stage application of the PCT application PCT/AU2017/050360 filed on Apr. 20, 2017 which claims priority to Australian application AU 2016901502 filed Apr. 22, 2016.

### BACKGROUND OF THE INVENTION

Real estate auctions have been conducted in a similar fashion for many years. A marketing campaign leads up to a physical auction, normally located at the premises to be auctioned. The only way to view and participate in the auction in real-time is by attendance. With thousands of auctions occurring every weekend, it is not always possible for buyers to attend all auctions they may genuinely have an interest in participating in. This limits the pool of buyers for vendors and also narrows the public's buying options.

Buyer's advocates may be utilised in lieu of attendance, with the advocate relaying information to the buyer via a phone call. However, this process fails to give the buyer a good understanding of the auction, relying completely on the advocate's interpretation of events.

If a property passes in without a bid, the agent is free to negotiate with anyone interested in the property. It is not until auction results are listed however, that people who were not able to attend the auction become aware of the failure to sell. These results are often not posted for a day or two after the auction and rely on interested parties physically seeking the auction result.

The process of the auction itself relies on an assistant to the auctioneer, recording any bids that may occur throughout the duration of the auction. These bids have traditionally been recorded on a handwritten piece of paper, verified and signed by the auctioneer on completion of the auction. This method is susceptible to the introduction of errors and the insecurity associated with hand written documents.

The reference to any prior art in this specification is not, and should not be taken as, an acknowledgement or any form of suggestion that the prior art forms part of the common general knowledge.

### SUMMARY OF THE INVENTION

According to one aspect of the invention, there is provided a computer implemented system for facilitating an auction comprising: a processor; a data store; and a communications interface; wherein the processor is configured to: receive auction information and optionally cause storage of at least part of said information in the data store; and cause transmission of auction information via the communications interface to one or more computing devices associated with a network.

In another aspect of the invention, there is provided a computer implemented method for facilitating an auction comprising receiving auction information and optionally causing storage of at least part of said information in a data store; causing transmission of auction information via a communications interface to one or more computing devices associated with a network.

Auction information may comprise any suitable information, for example, information about an item offered for auction, details relating to entities interested in the item, status of the auction, historical data relating to previous sales of the or similar items, bid information etc. In some embodiments the auction information transmitted comprises video footage and in some preferred embodiments, the video footage is live footage and in some embodiments, corresponding audio is transmitted at the same time.

In another aspect of the invention, there is provided a system for facilitating an auction, comprising: a remote client interface coupled to a network; a video system coupled to the network and that is configured to capture and transmit live video from the auction towards a remote client over the network while maintaining a delay of approximately two seconds or less, the remote client coupled to the network and configured to receive the live video from the video system, receive information pertaining to an item being auctioned at the active auction and to transmit a bid of the entity for the item being auctioned; a processing system configured to: process auction bids received from one or more bidders and the client for the item being auctioned; transmit to the client over the client interface information pertaining to the item being auctioned; receive auction bids from the one or more clients through the client interface for the item being auctioned; transmit the live video and transmit information regarding the auction status to client over the client interface; adjust the amount of data being transmitted when it interferes with the handling of key information (such as bids) by causing a delay of more than approximately two seconds.

In another aspect of the invention, there is provided a computer generated auctioneer dashboard to enable an auctioneer or entity running a plurality of auctions (such as a real estate agent or online auction platform) to monitor and control various aspects of one or more of the auctions and optionally customer and potential customer relationship management functions.

The invention takes a multifaceted approach to real estate auctions. Incorporating features and technology that benefits vendors, buyers, agents, auctioneers and homeowners. In real time, real estate auctions can be viewed and participated in from remote locations utilising the mobile or web components of the platform. Instant communication can occur between buyers and agents before, during or after an auction.

The mobile and web components of the invention allow agents to publicly list details of properties they are selling via auction. These details include all the relevant information pertaining to the property, as well as details of the auction. Users may opt to shortlist properties, storing the property in a quick access list which automatically notifies the user when the auction goes live. Alternatively, all currently live auctions are highlighted and visible to all users.

Registered agents and auctioneers are able to live stream their auctions utilising the mobile application and their smartphone camera, or from a Wi-Fi connected external camera controlled from the tablet application. The live auction stream preferably has less than 2 seconds latency for all users, irrespective of the device used. It will also be available up to HD quality, adapting resolution dependent on the user's network data availability.

In some embodiments, a user may provide video stream to the system via their own mobile device. This may be handled in any suitable way, for example, the operator of the invention may require pre-registration, or certain minimum technical features such as hardware, processor, bandwidth available from the device, etc. The operator of the invention may offer such video streams in any suitable way, for example, to all users via an interactive display, or may offer such video via a third party platform, or to selected users which may for example be associated with the user providing the video stream, for example via a social networking platform.

The auction stream may be commenced, paused and concluded from the mobile device, such as a phone or tablet, with advertising material displayed during a pause in the auction. Agents receive live viewer analytics throughout the auction, including: viewer numbers, the shortlist total for the property and the number of people actively interested in the property. The agent can also view details related to online bidding, including: bid history, bid value, bid time stamps and bidder details.

General users viewing the live stream have the option to register live interest in the property via a one-click submission. User contact details automatically populate the associated agent's leads database. Registered bidders are able to submit bids from mobile devices, pending approval from the agent controlling the auction.

On completion of the auction stream, the agent is able to state whether the property sold or passed in. A detailed summary of the auction is automatically generated, with auctioneers able to confirm authenticity with their digital signature. The agent then has the option to send marketing notifications to stream subscribers, related to the auction result or for example the type of property offered at the auction.

Successful online bidders will be in instant communication with the agent, ensuring details have been confirmed and legal requirements met. Once these have been confirmed, the platform will store previous auction data allowing users to view recent results.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

FIG. 1 depicts a flow diagram showing typical steps performed by a general user (subscriber).

FIG. 2 is a flow diagram showing typical steps performed by an authorised agent (broadcaster).

FIG. 3 is a high-level data flow diagram showing data flow within a typical arrangement of components and software.

FIG. 4 shows wireframes and user flow for users logging in or signing up through an example mobile application.

FIG. 5 shows wireframes and user flow for screens that share the map and list functions on an example mobile application.

FIG. 6 shows example features of the upcoming auction map screen.

FIG. 7 shows wireframes and user flow for property detail and profile screens of an example mobile application.

FIG. 8 shows wireframes and user flow for the general user menu and property detail filter screens of an example mobile application.

FIG. 9 shows an example of the live streaming overlay visible to a general non-bidding user.

FIG. 10 shows an example live streaming overlay visible to a registered bidding user when the stream is launched from the agent tablet application.

FIG. 11 shows example wireframes and user flow of the agent home and menu screens for an authorised agent using the mobile application.

FIG. 12 shows example wireframes and user flow of the create new and edit auction screen for an authorised agent using a mobile application.

FIG. 13 shows wireframes and user flow for the current listings, camera selection and live stream screens for an authorised agent using an example mobile application.

FIG. 14 shows example screens that may form the agent's tablet application.

FIG. 15 shows wireframe of the leads screen for an authorised agent using an example tablet application.

FIG. 16 shows a wireframe of the auction control dashboard screen for an authorised agent using an example tablet application.

FIG. 17 shows the server database structure for the auction control dashboard of an example tablet application.

### DETAILED DESCRIPTION OF EXEMPLARY EMBODIMENTS

It is convenient to describe the invention herein in relation to particularly preferred embodiments referred to herein as the GAVL platform, or GAVL. However, the invention is applicable to a wide range of implementations and it is to be appreciated that other constructions and arrangements are also considered as falling within the scope of the invention. Various modifications, alterations, variations and or additions to the construction and arrangements described herein are also considered as falling within the ambit and scope of the present invention.

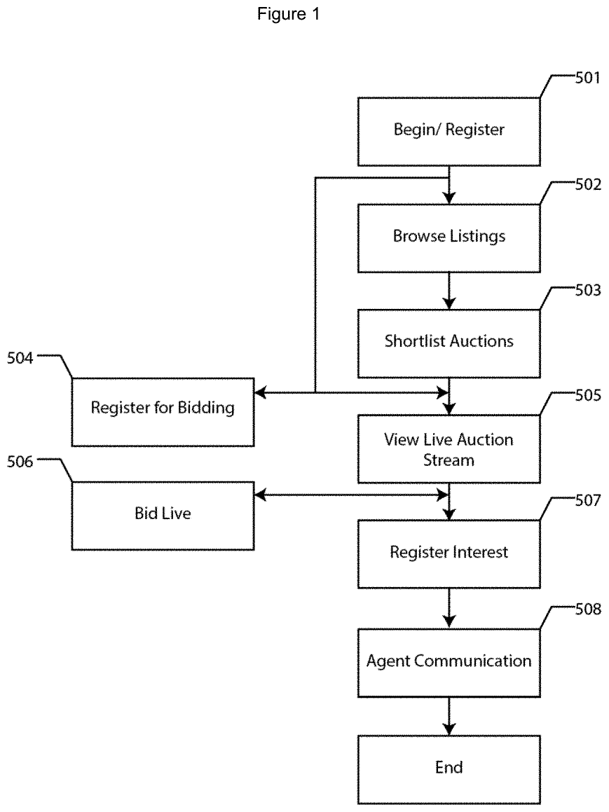

FIG. 1 is a flow diagram demonstrating the typical steps a general user will perform. General users begin 501 by registering for an account or by logging in using an existing personal account. They may then browse upcoming or currently live auction listings 502, shortlisting any properties they wish 503. The user may at this point contact the relevant real estate agent to register for live bidding 504. If successful, the user's account will be updated to allow live bidding for that particular property only. All users will then be able to view the live auction stream 505, with registered bidders able to submit in-platform bids 506. Unregistered bidders are able to register live interest and send their expressions of interest directly to the agent 507. On completion of the auction, agents are able to communicate the result or negotiate directly with interested users 508.

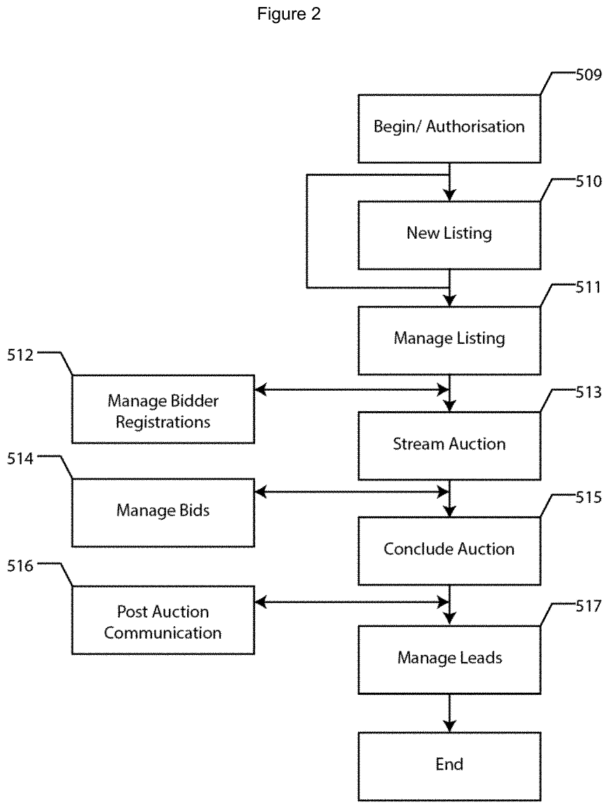

FIG. 2 is a flow diagram demonstrating the typical steps a registered agent/auctioneer will perform. GAVL authorised agents begin by logging in using their login information 509. They may then create a new in-platform listing 510. Alternatively they may manage any listings previously registered to their account, either created in-platform or imported from an external CRM using an API 511. Agents are prompted to authorise any users interested in bidding, provided that they meet all criteria determined by the real estate agency 512. GAVL will adjust user's profiles that have been successful in registering for live bidding when directed by the real estate agency. The agent will utilise the platform to commence live streaming at the appropriate time and location 513. During the auction, the agent will use the platform to manage live online and onsite bids 514. On conclusion, the agent may opt to communicate with interested parties 517 or simply notify users of the auction outcome 516.

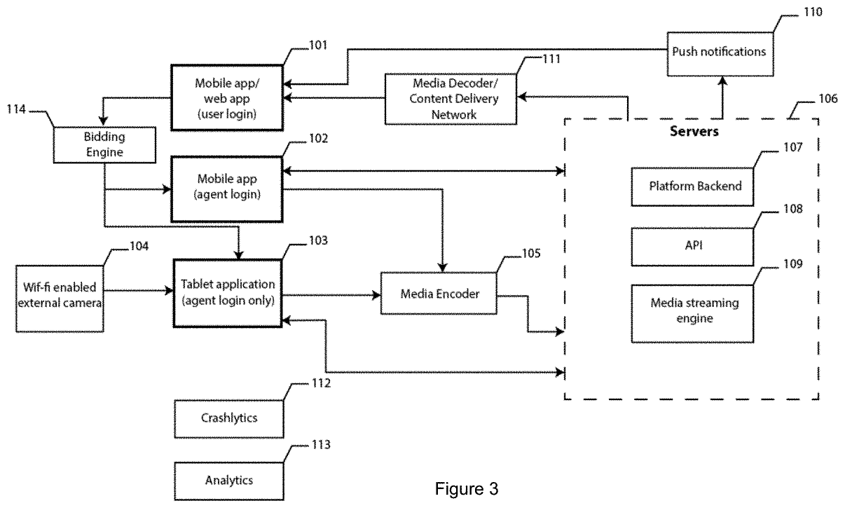

FIG. 3 is a high-level data flow diagram, demonstrating the infrastructure and data flow necessary for the platform to operate in its entirety. Elastic cloud servers 106 house the backend databases used for push notifications 110, file storage, administration, monitoring, configuration, API 108 and the media streaming engine 109. When an agent launches a live stream from the mobile application using the inbuilt camera 102, the video is live encoded 105 and wirelessly transferred to the media streaming engine 109 for processing and distribution. Streams requested from users are pulled via a content delivery network 111 and decoded 111 into a suitable format on the mobile and web platform 101. The framework allows an adaptive bitrate stream with a max resolution of 720p and less than 2 seconds of latency to be viewable by users. The tablet application 103 and external camera control function of the mobile application 102 allow agents to control and live stream from an external camera 104 via an ad-hoc WiFi network. The audio and video data then travels via the same pathway to the user as the mobile camera signal. Live bidding is enabled by a secured external webRTC platform 114. Crashlytics 112 are recorded by a third party service, with user analytics 113 recorded and stored on the elastic cloud servers 106.

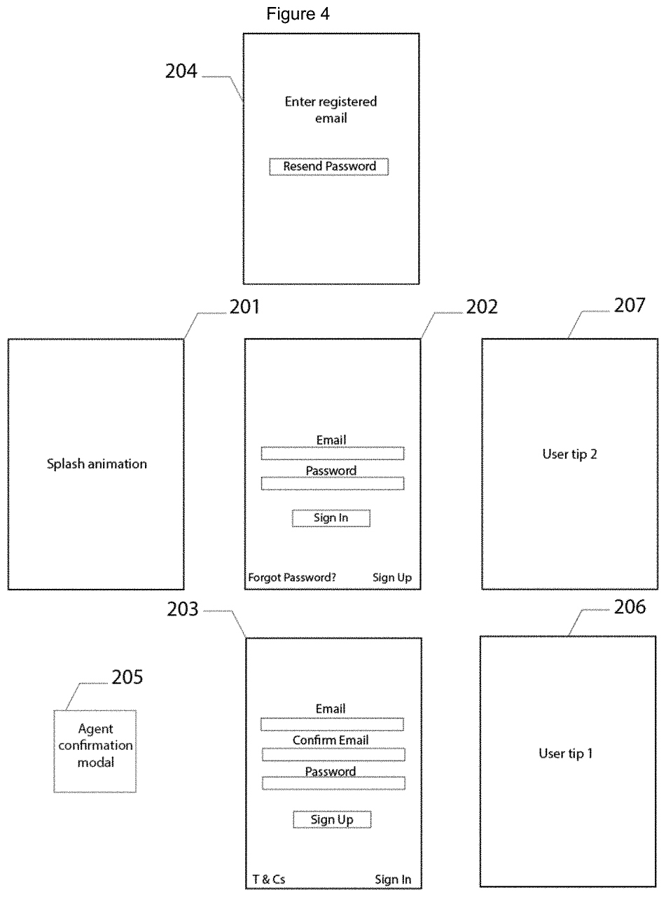

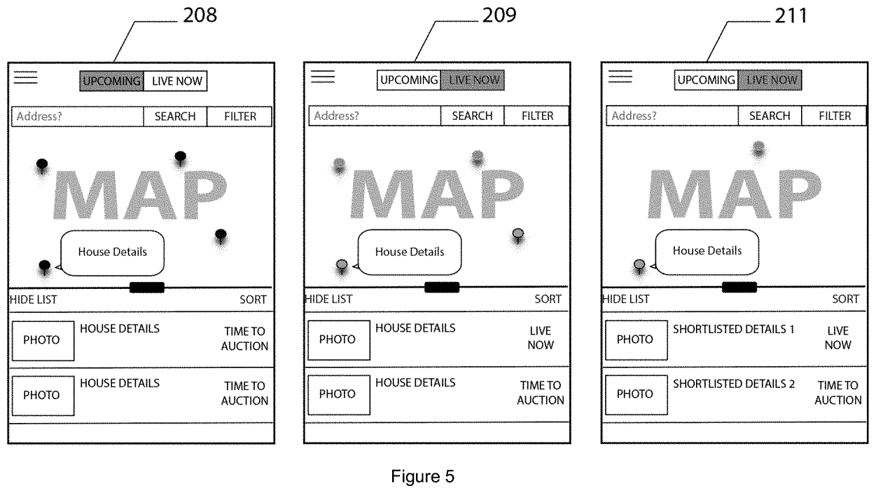

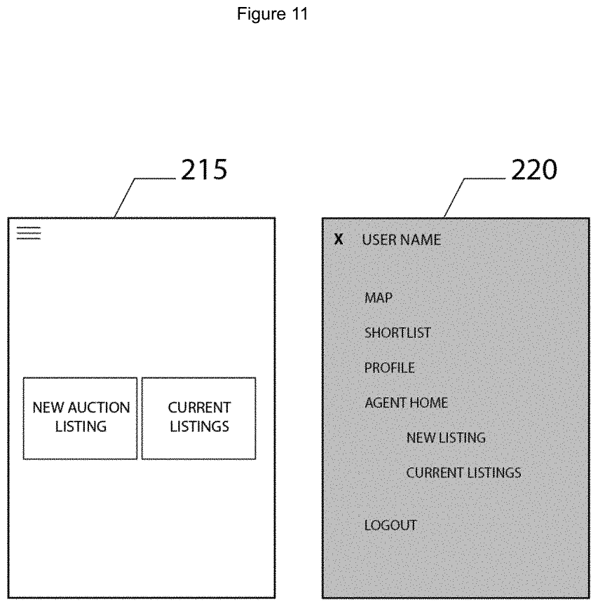

FIG. 4 details the screens and functions available to a general user accessing the mobile application. When first launched, the mobile application displays a splash page 201 with a GAVL specific animation. The user is then transferred to the login page 202, wherein registered users/agents can enter their unique email address and password to enter the application. They may also navigate from this page to the password reset page 204 or registration page 203. The password reset page 204 incorporates a password recovery system, whereas the registration page 203 consists of registration data entry fields. On completion of the registration page 203, all users are prompted to confirm whether they are requesting an agent account 205. If so, the registration process is paused until a GAVL representative confirms their credentials and then their account is adjusted and the agent navigated to the agent home page 215 FIG. 11. All other successful non-agent registrations are given application instructions via 206 and 207, landing on the upcoming map page 208 FIG. 5 afterwards.

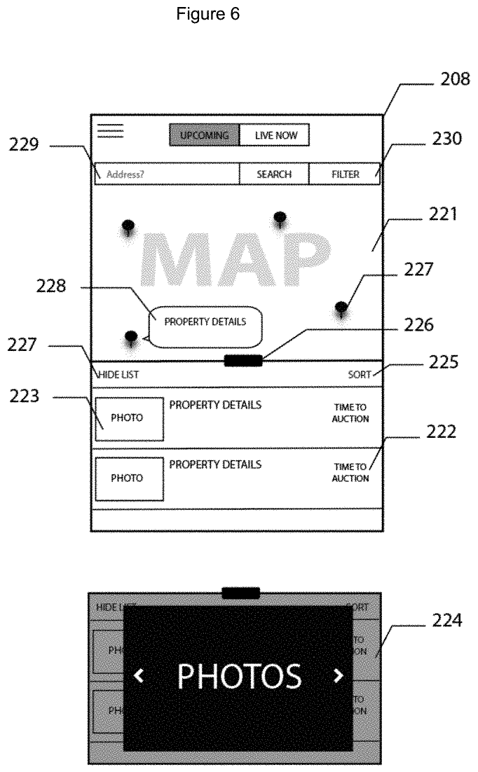

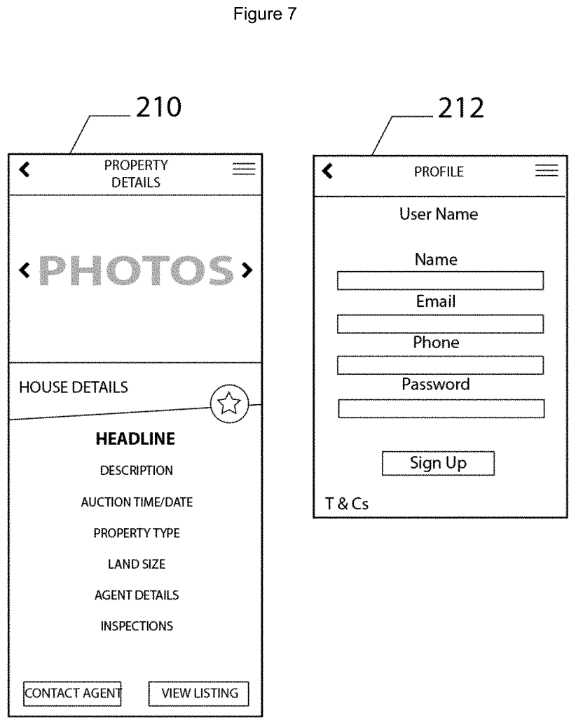

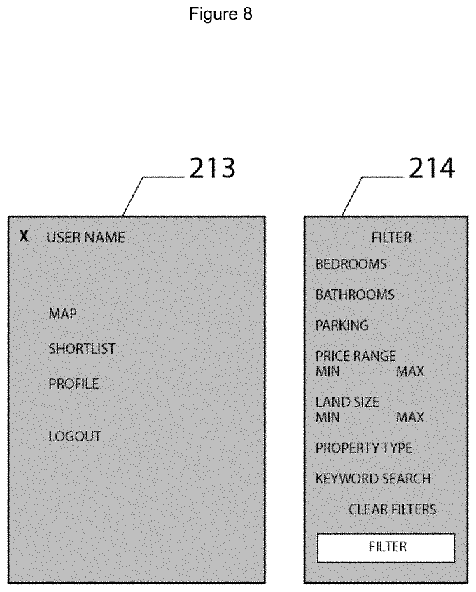

FIG. 6 is a detailed version of the upcoming map screen 208. This screen shares the same features as FIG. 5's live now map screen 209 and the shortlist screen 211. The only differences between the screens are that screen 209 lists auctions either currently in progress or due to commence in the next 24 hours. Whereas the shortlist screen 211, lists properties that have been previously added to the user's shortlist from the property details screen FIG. 7 210. Shared functions include an interactive third party street map 221, with properties represented by an icon on the correct map location 227. Pressing these icons once displays a callout 228 with basic property details: address, bedrooms, bathrooms, carparks and price range. It also causes the enhanced property details 222 to be displayed at the top of the property details list 226. The enhanced details 222, includes all the information from the callout 228 but also a countdown to the scheduled auction commencement time and a thumbnail image of the property 223. By clicking on the thumbnail image 223, an enlarged image carousel modal 224 is displayed over the map screen 208. Clicking anywhere outside of the images will dismiss the modal 224. The list 226 may be hidden 227 or dragged to cover a larger or smaller portion of the map 221. It may also be sorted 225 by: newest to oldest listing, soonest auction or ascending price. Cities, suburbs, streets or specific addresses may be searched using an autocomplete data entry field 229. Properties can be filtered 230 by: bedrooms, bathrooms, parking, price, land size, property types or by searching for a keyword. The filter button 230 displays the filter menu 214 FIG. 8. Double clicking either a property icon 227 or the enhanced property details 222 transfers the user to the relevant property details page 210 FIG. 7.

The property details screen 210 shown in FIG. 7, is used to display the property's sales information populated automatically from the agent's CRM via API or entered manually from the agent in-platform. As previously mentioned, users may add the specific property to their shortlist enabling a push notification when the auction stream is live or reviewing the details on the shortlist screen 211 at a later time. Users may also register interest in the property, contact the agent directly or view the listing on the agent's own website. The menu button present on the core screens 208 FIG. 5, 209 FIG. 5, 210 FIGS. 7, 211 FIG. 5 and 212 FIG. 7 is used to display the application menu. The user may then have direct access to the core screens, including the user profile screen 212 FIG. 7. This screen permits the user to edit and store their profile data and review the terms and conditions of the platform.

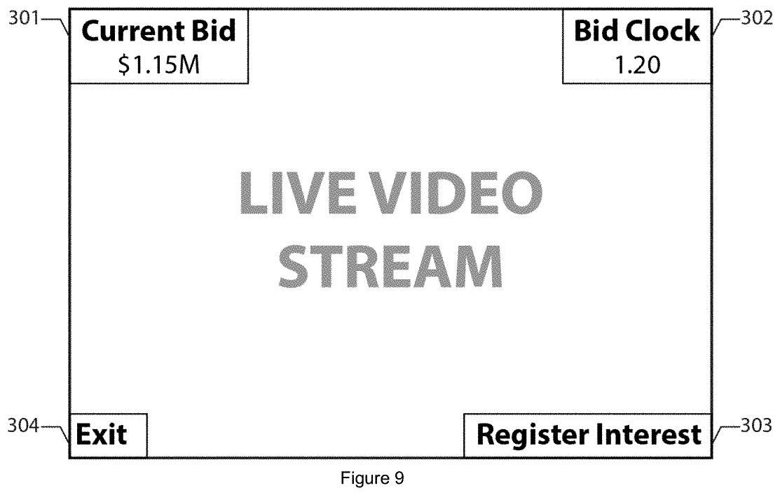

FIG. 9 is a diagram detailing the mobile application screen available to a non-registered bidder when a live auction stream has been launched by the agent. The live video stream runs underneath the dynamic overlay. Users may send their profile contact information through to the agent's leads database and email via the register interest button 303. Utilising the third party webRTC platform and input from the agent's tablet dashboard, users are shown the current bid value 301 and the time since a bid was last made 302. The stream may be left at anytime using the exit button 304.

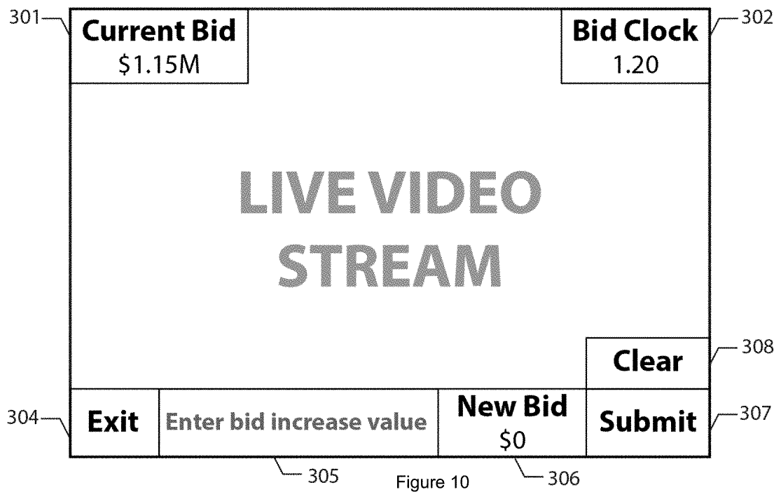

FIG. 10 is a diagram detailing the mobile application screen available to a registered bidder when a live auction stream has been launched by the agent from the tablet application. The overlay and stream are structured in a similar manner to FIG. 9 with the dynamic data 301, 302 and the exit button shared by both. Bid increase values may be entered in the numerical entry field 305, with the dynamic new bid field 306 adjusting accordingly: bid increase+current bid=new bid. The new bid value 306 may then be cleared 308 or submitted to the agent 307 for approval via the tablet application and webRTC protocol.

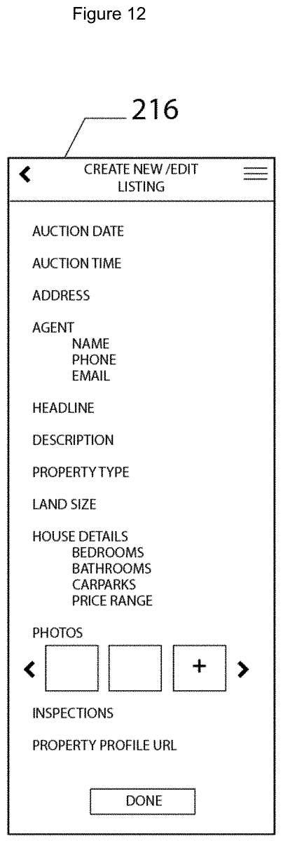

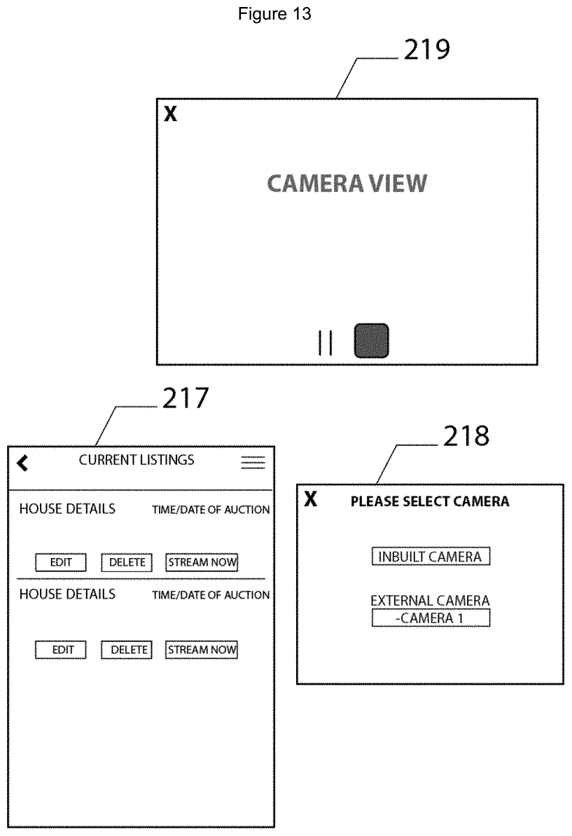

FIGS. 11, 12 and 13 detail the user flow and interactions available to a registered agent logged in to the mobile application. The agent home screen 215 FIG. 11 allows the agent to navigate to current listings 217 FIG. 13 registered to their account or create a new auction listing 216 FIG. 12. The create new listing screen 216 contains data entry fields used to populate the property details screen 210 in FIG. 7. Information includes: auction data, auction time, address, agent details, headline, description, property type, land size, bedrooms, bathrooms, carparks, price range, inspections, agent's property profile URL and photo upload function. This screen is also used to edit pre-populated data from existing listings when editing is launched from the current listings screen 217 FIG. 13. Agents may also delete listings here or opt to commence a live auction stream, in turn opening the camera selection modal 218. If a WiFi connected external camera is available at this point, the agent can opt to stream from that device or use the inbuilt camera. Both actions launch the streaming screen 219. The agent can see the stream and opt to start, stop or pause it from the control overlay. Pausing the stream prompts marketing material to be displayed to users in place of live video. Stopping the stream, removes the stream from the live now list and archives the listing details.

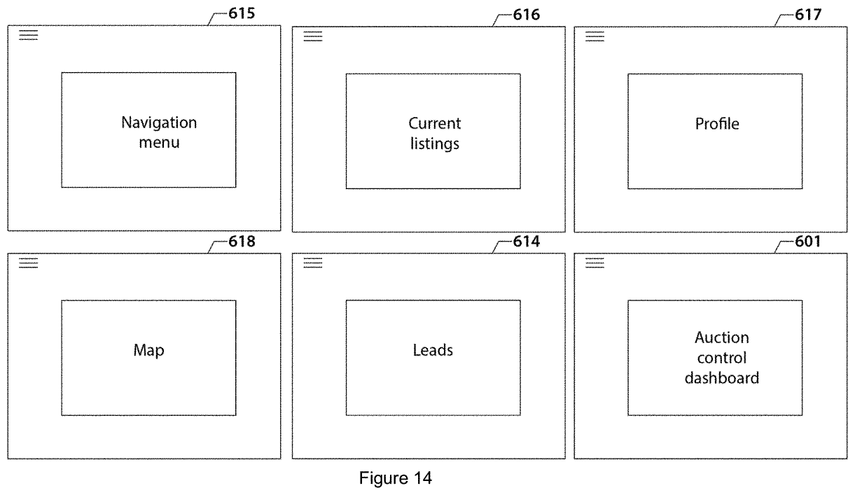

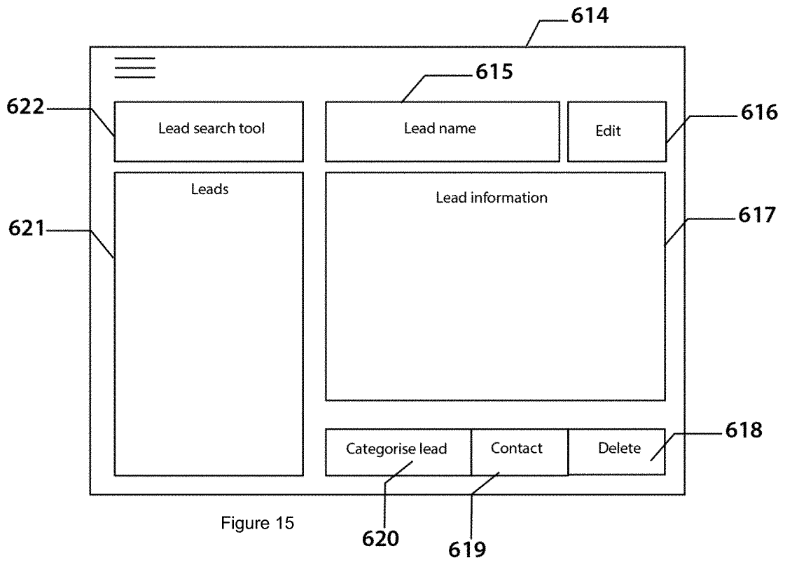

Authorised agents also have the option to use the tablet application 103 FIG. 3 as a means of conducting and facilitating the auction process through the GAVL platform. FIG. 14 shows the screens that make up the tablet application. Login and sign up is conducted through the same framework as an agent utilising the mobile application. The navigation menu screen 615 is the landing page for the agent upon successful login. From here they may conveniently navigate to any of the other screens by one click. The current listing screen 616 shares the same components and functionality as the agent's mobile application screen 217 FIG. 13. The profile screen 617 and map screen 618 also share the same components and functionality as their respective pages on the mobile application. The leads screen 614 is unique to the tablet application and is the front-end access point for the leads database populated by users registering interest in particular properties. FIG. 15 displays the components located on the leads screen of the tablet application. Leads are listed under the property they registered interest in, throughout the leads list 621. Agents may use the search tool 622 to find individual leads or particular property listings. When a lead is selected on the leads list 621, their name 615 and contact information 617 is displayed on the page. Lead contact information may be edited at any point by the associated agent using the edit function 616. Agents may also delete leads 618 from the database or categorise them by level of interest 620. If an agent would like to directly email the lead, they may do so from the contact button 619 on this screen.

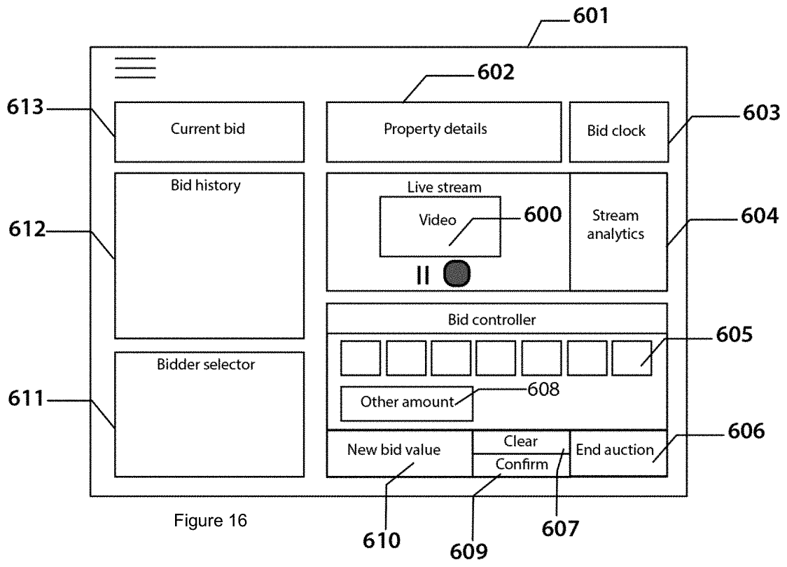

Should an agent wish to begin an auction they may do so from the auction control dashboard 601 FIG. 16. Upon entry to the page the agent selects the relevant property associated to their profile from the property details selection tool 602. The agent can then select a WiFi connected camera, control and view the live stream from the live stream control window 600. Analytics related to the stream such as the live number of viewers are displayed in the analytics window 604. The dashboard also has the capability to be used as a bid scriber's tool, whereby bidders can be registered 611 and bid values inputted through the quick value selection buttons 605 or manual numerical entry window 608. The bid increase value and current bid value 613 are added together and displayed in the new bid value display 610. The agent then has the option to confirm 609 or clear 607 this bid as well as any bids received from registered users. If the bid is confirmed, the current bid value 613 is updated as is the bid history list 612 user's overlay 301 FIG. 9 and the bid clock 603 reset to 0. Once an auction is completed, the agent selects the end auction button 606 and is prompted to state whether the auction passed in or sold. An auction summary is then generated and a digital signature required from the auctioneer to confirm the validity of the auction summary. This is then sent to GAVL and the associated agent. Online registered bidders who have successfully bid on the property will be contacted outside of the application by the agent to complete the purchase process.

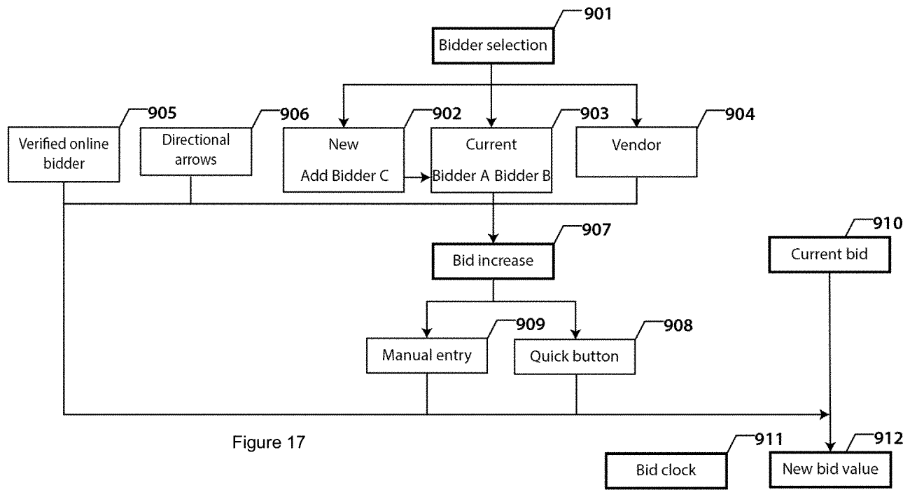

FIG. 17 shows the server database structure for the auction control dashboard. When an auction is commenced a database tied to the individual property is generated. This database initially populates the current bid field 910 with a value of zero. The up counting bid clock 911 begins counting, restarting the count on the confirmation of a new bid. As previously mentioned this value and the current bid value 910 are rendered on a subscriber's stream overlay FIGS. 9 and 10. To place a new bid, the bidder selection field 901 must be populated with an associated variable. The initial variables available are vendor 904 and the directional arrows to indicate the location of the bidder 906. A new bidder variable may be added 902, this value will then become available as a current bidder selection 903 along with any other unique new bidders generated. After the bid selection field 901 has been populated, the bid increase field must be populated. This can be completed by the agent through the quick entry buttons 908, with pre-determined values associated to them. The agent may also manually enter the value into the numerical entry field 909. After both the bidder selection field 901 and bid increase field 907 have been populated, the agent is able to submit the bid. Submitting the bid populates the new bid field 912 and adds this value to the current bid value 910, a time stamp is also placed in the associated array. The process may be repeated up until the cessation of the auction, with values listed in the database in chronological order. At any point throughout the auction, authorised bidders may submit a bid to be confirmed or rejected by the controlling agent. If confirmed, the online bidders unique identifier 905 populates the bidder selection field 901 and the value of bid populates the bid increase field 907. In turn the new bid value 912 and current bid value are also updated 910.

In some embodiments, the invention comprises an automated auction engine to process bids. The bid processing system may take on a variety of embodiments. As, an example, data for an item to be sold in the auction can be extracted from a catalogue system that maintains the pre-sales information prior to the auction start, and transferred to a bid system, and broadcast to various bidder devices. Bidding devices may for example interface directly with a catalogue system to obtain such information. A starting bid is established for example, based on the pre-sales information, or by the auctioneer, and then bids are accepted. Status pertaining to the bidding process, such as bids placed, identity of bidding participants, bid acceptance, etc. may be transmitted to the bidder devices, and logs can be maintained identifying activity including status of each bid made by a remote bidder or local bidder.

The bid system may include an algorithm to control the bidding process. The bid engine can be implemented to support one or more bidding models to control the bidding process. The various bidding models can be used to define variables such as the level of automation in the bidding process, the bid increments, the ability to enter starting bids, display formats, etc.

In its simplest implementation, the bidding device needs to include a display, a user input interface, a bid processing system interface, a processing unit for executing a software or firmware process implementing the various steps involved in present invention and optionally an audio and/or video output interface. Thus, the bidding device may be a stand alone computer, a networked computer, a laptop computer, a tablet computer, a smart phone, a custom handheld portable device, a software application that can be downloaded onto a computer or portable device, such as a smart phone, etc.

Aspects of the present invention can be implemented using a variety of hardware platforms, software languages and programming environments. Those skilled in the art will readily observe that implementing the present invention in various environments will naturally require the use of various technologies. However, the present invention is not limited to any particular division of hardware/software functionality, hardware components, software languages, or programming techniques. Thus, references within this description identifying design particulars, although in and of themselves may be considered novel and inventive, are provided only for illustrative purposes and should not be construed to limit the present invention but rather are additive.

A user uses a client to access and interact with the system of the invention. The client can be any type of computer device, such as a personal computer (e.g., desktop, notebook, laptop computer), as well as devices such as a mobile telephone or personal digital assistant that has the capability to record video content. The client typically includes a processor, a display device (or output to a display device), a local storage, such as a hard drive or flash memory device, to which the client stores data used by the user in performing tasks, and a network interface for coupling to the system of the invention via a network.

The network enables communications between the clients and the system of the invention. In one embodiment, the network is the Internet, and uses standardized internetworking communications technologies and protocols, known now or subsequently developed that enable the clients to communicate with the system of the invention. In another embodiment, the network is a cloud computing network and may include one or more components of the system of the invention.

In one embodiment, the network uses a fast network protocol, such as SPDY protocol, for video content delivering. Compared with traditional TCP/IP and HTTP protocols, SPDY protocol supports multiplexed video streams and service request prioritization. To support multiplexed video streams, SPDY protocol allows for multiple concurrent video streams over a single TCP connection. Because TCP requests with SPDY protocol are interleaved on a single channel, the efficiency of TCP is much higher than traditional TCP protocol. In other words, fewer network connections need to be made, and fewer but more densely packed data packets are issued.

SPDY protocol also supports service request prioritization. A client can send many service requests to a computer server for content delivery services, and assign a priority to each service request. Prioritizing service requests in this way prevents the network channel from being congested with non-critical resources when a high priority request is pending.

Reference in the specification to “one embodiment” or to “an embodiment” means that a particular feature, structure, or characteristic described in connection with the embodiments is included in at least one embodiment of the invention. The appearances of the phrase “in one embodiment” or “a preferred embodiment” in various places in the specification are not necessarily all referring to the same embodiment.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the invention include process steps and instructions described herein in the form of a method. It should be noted that the process steps and instructions of the invention can be embodied in software, firmware or hardware, and when embodied in software, can be downloaded to reside on and be operated from different platforms used by a variety of operating systems.

The invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

What is claimed is:

1. A computer implemented system for facilitating an auction of physical property comprising: a processor; a data store; and a communications interface; wherein the processor is configured to: receive auction information and optionally cause storage of at least part of said information in the data store; and cause transmission of auction information via the communications interface to one or more computing devices associated with a network.

2. A system according to claim 1, comprising a media encoder to enable transfer of near-real time audio and or video data from the auction to one or more computing devices associated with a network.

3. A computer generated auctioneer dashboard rendered on a display, the dashboard enabling: monitoring of one or more auctions; selection of a property associated with an auction; control of audio and or video data capture and transfer; capture of auction information; management of a customer relationship; and management of an auction.

4. A system for facilitating an auction, comprising: a remote client interface coupled to a network; a video system coupled to the network and configured to capture and transmit near real-time video from the auction to a remote client over the network, the remote client coupled to the network and configured to receive live video from the video system, receive information pertaining to an item being auctioned at the active auction and to transmit a bid of the entity for the item being auctioned; a processing system configured to: process auction bids received from one or more bidders and the client for the item being auctioned; transmit to the client over the client interface information pertaining to the item being auctioned; receive auction bids from the one or more clients through the client interface for the item being auctioned; transmit the live video and transmit information regarding the auction status to client over the client interface; and optionally adjust the amount of data being transmitted when it interferes with handling of key information optionally by causing a delay.
